(19) United States
(12) Patent Application Publication
(10) Pub. No.: US 2016/0255771 A1
(43) Pub. Date: Sep. 8, 2016

(54) IRRIGATION FERTILIZER VALVE

(71) Applicants: Wayne Moras, Bethel, MN (US); Carrrie Moras, Bethel, MN (US)

(72) Inventors: Wayne Moras, Bethel, MN (US); Carrrie Moras, Bethel, MN (US)

(21) Appl. No.: 15/056,037

(22) Filed: Feb. 29, 2016

Related U.S. Application Data
(60) Provisional application No. 62/127,341, filed on Mar. 3, 2015.

(51) Int. Cl. A01C 23/04; A01C 23/00; A01C 21/00

(52) U.S. Cl. CPC A01C 23/042; A01C 21/00; A01C 23/007

(57) ABSTRACT

An irrigation system comprises a water supply, a plurality of irrigation heads in fluid connection with the water supply, and a fertilizer assembly between the water supply and a first irrigation head, the fertilizer assembly in fluid connection with the water supply and the first irrigation head, the fertilizer assembly comprising a fertilizer valve connected to a fertilizer container. Water is provided from the water supply to the fertilizer assembly, where it is mixed with fertilizer provided via gravity from the fertilizer container in the mixing chamber to form fertilized water. The fertilized water is then provided to at least one of the irrigation heads of the system.

### CROSS-REFERENCE TO RELATED APPLICATIONS

This application claims priority to Application Ser. No. 62/127,341, entitled “Irrigation Fertilizer Valve” and filed on Mar. 3, 2015, and which is hereby incorporated by reference herein in its entirety.

### FIELD OF THE INVENTION

This invention relates generally to valves for use in depositing fertilizer on lawns and gardens.

### BACKGROUND OF THE INVENTION

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

To promote healthy lawns, trees, and other plants, property owners, property managers, and farmers often use fertilizers at various times of the year depending on conditions. Fertilizers may be harmful to the user, their families, their pets, and other animals, especially granule fertilizers that remain on the surface of the lawn. Handling fertilizers may affect a person's health. Additionally, the application of fertilizers to lawns may be affected by rain, wind, or other factors that may reduce the effectiveness of the fertilizer. There is a desire to provide a system that effectively and safely fertilizes lawns, trees, and other plants.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to an irrigation system for a residential property, commercial property, parks, golf courses, athletic fields, schools, or other property, which may have grass, trees, and other plants that require watering and fertilizing to maintain plant health.

In one embodiment, an irrigation system, comprises a water supply; a plurality of irrigation heads in fluid connection with the water supply; and a fertilizer assembly between the water supply and a first irrigation head, the fertilizer assembly in fluid connection with the water supply and the first irrigation head, the fertilizer assembly comprising a fertilizer valve connected to a fertilizer container with a stored amount of fertilizer. The fertilizer valve may comprise a body having a top, a bottom, a first side, and a second side; a water inlet on the first side; an outlet on the second side, the outlet in fluid communication with the water inlet; and a fertilizer inlet on the top of the body. In some embodiments, the fertilizer valve further comprises a mixing chamber connected to the fertilizer inlet, the water inlet, and the water outlet.

In some embodiments, a portion of the stored amount of fertilizer may be transferred to the mixing chamber based on gravity. The portion of the stored amount of fertilizer in the mixing chamber is combined with water provided from the water supply to form fertilized water. In some embodiments, the fertilized water is transferred to the at least one of the irrigation heads. In some embodiments, the fertilizer valve further comprises a first connector at the fertilizer inlet that connects with a second connector on the fertilizer container. In some embodiments, the system further comprises a sprinkler control valve between the fertilizer valve and the first irrigation head. The irrigation system of claim 1, wherein the sprinkler control valve controls flow of fertilized water to a first irrigation head. The fertilizer assembly may be installed in a fixed position, or in other embodiments, the fertilizer assembly may be movable from a first installed position to a second installed position. For instance, the fertilizer assembly may be installed in a first position between the water supply and the first irrigation head and installed in a second installed position between the first installed position and a second installed position. In some embodiments, multiple fertilizer valves may be installed throughout the irrigation system.

In some embodiments, a fertilizer valve comprises a water supply; a plurality of a body having a top, a bottom, a first side, and a second side; a water inlet on the first side; an outlet on the second side, the outlet in fluid communication with the water inlet; and a fertilizer inlet on the top for connection with a fertilizer container. In some embodiments, the fertilizer valve further comprises a mixing chamber connected to the fertilizer inlet, the water inlet, and the water outlet. In some embodiments, the fertilizer valve further comprises a puncturing feature at the fertilizer inlet for opening a safety closure on the fertilizer container. In some embodiments, the fertilizer valve further comprises a shut-off feature that controls feed of fertilizer from the fertilizer container. In some embodiments, the fertilizer inlet comprises a connector for connecting with a connector on a fertilizer container.

A method of fertilizing plants for an irrigation system having at least two irrigation heads may comprise providing water from a water supply to a fertilizer assembly, which comprises a fertilizer valve connected to a fertilizer container with fertilizer, the fertilizer valve comprising a water inlet on one side, an outlet on another side in fluid communication with at least two irrigation heads, and a fertilizer inlet in communication with the fertilizer container; mixing the water with fertilizer provided via gravity from the fertilizer container in the mixing chamber to form fertilized water; and providing the fertilized water to at least a first irrigation head. The method may further comprise connecting a fertilizer container to the fertilizer inlet. In some embodiments, the method may further comprise controlling an amount of fertilizer distributed from the fertilizer container.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic drawing of the irrigation system of one embodiment of the invention.

FIG. 2 is a cross-sectional view of one embodiment of the irrigation system of the present invention.

FIG. 3 is a front view of one embodiment of a fertilizer assembly of the present invention.

FIG. 4 is a top view of one embodiment of a fertilizer valve of the present invention.

### DETAILED DESCRIPTION

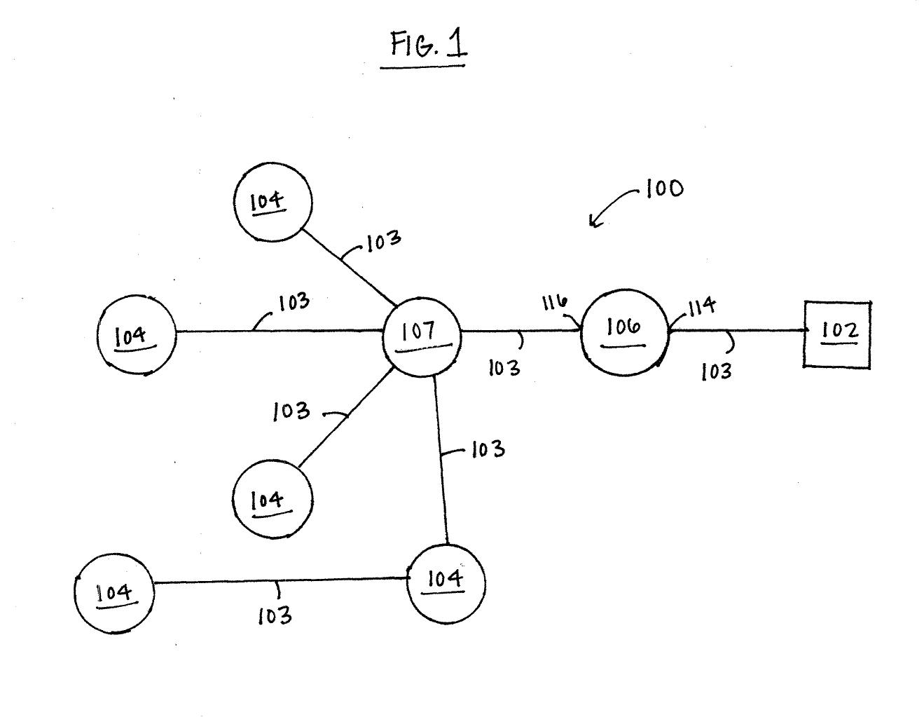

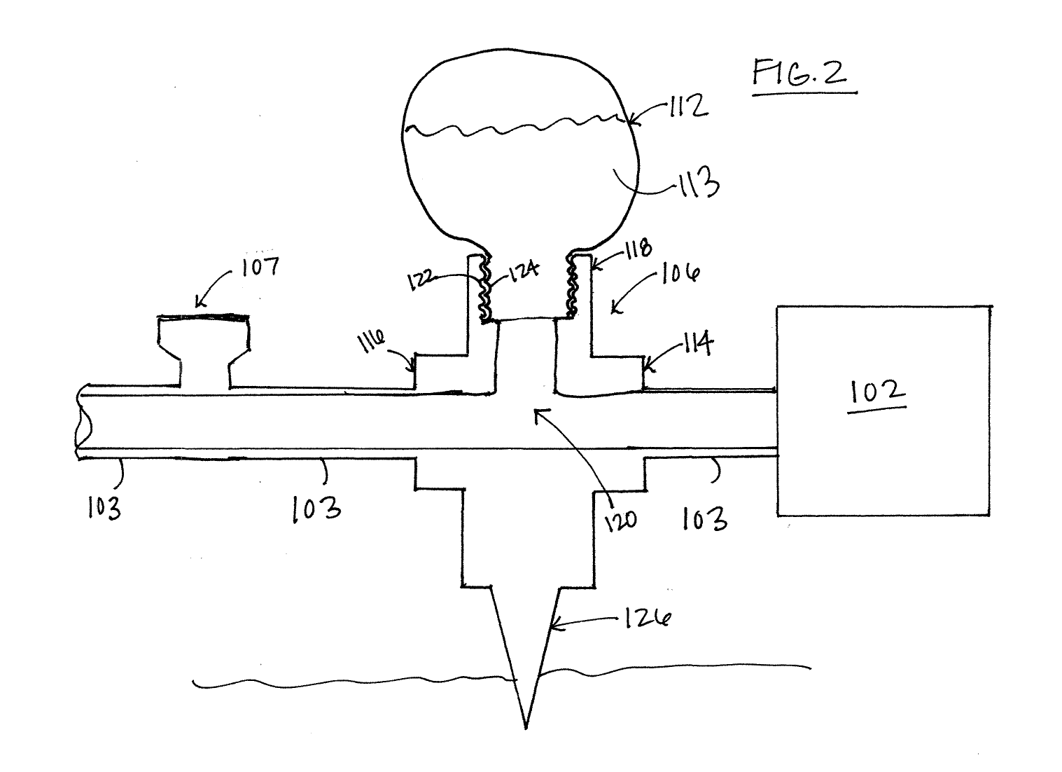

The present disclosure relates to novel and advantageous irrigation systems and devices. As shown in FIG. 1, irrigation system 100 comprises a water supply 102, a plurality of irrigation heads 104 in fluid connection via piping 103 with the water supply 102, and a fertilizer assembly 106 in fluid connection via piping 103 with the water supply 102 and at least one of the irrigation heads 104. In at least the embodiment shown, fertilizer assembly 106 is positioned distally from the water supply 102 and proximally to a sprinkler control valve 107. In some embodiments, the water supply 102 may be located inside a building. In some embodiments, the water supply 102 may have a shut-off valve, which can be opened to allow water to flow through the system or closed to stop water from flowing through the system. In at least the embodiment shown, fertilizer assembly 106 is positioned distally from the water supply 102 and proximally to a sprinkler control valve 107. FIG. 2 shows a cross-sectional view of a portion of irrigation system 100 with a water supply 102, a sprinkler control valve 107, and a fertilizer assembly 106 in fluid connection via piping 103 with the water supply 102 and the sprinkler control valve 107. The fertilizer assembly 106 comprises a fertilizer valve 110 and a fertilizer container 112. The fertilizer container 112 may be provided with an amount of fertilizer 113, which may be a granule or liquid fertilizer. The amount of fertilizer may be predetermined based on factors related to the use of the irrigation system, which include but are not limited to, size of the area being fertilized, type of plants being fertilized, season of use, geographic region, and duration of the fertilizing process. As shown in FIG. 2, the fertilizer valve 110 comprises a water inlet 114, an outlet 116 in line with the water inlet 116, and a fertilizer inlet 118. The water inlet 114, the outlet 116 and the fertilizer inlet 118 are connected to a mixing chamber 120. The fertilizer inlet 118 further comprises a connector 122 that mates with a connector 124 on the fertilizer container 112. In some embodiments, the connectors 122, 124 may be threaded connectors to form a threaded connection, or they may comprise quick connect fittings or other known connectors. The fertilizer container 112 is installed onto the fertilizer inlet 118 in an upside-down configuration, such that the fertilizer flows into the mixing chamber 120 under gravity. In the upside-down configuration, the top of the fertilizer container mates with the top of the fertilizer valve, where the fertilizer inlet is positioned on the top of the fertilizer valve. In at least one embodiment, water flows from the water supply through the fertilizer assembly into the mixing chamber where it mixes with fertilizer to form fertilized water. Then the fertilized water flows to at least the sprinkler control valve and then onto at least a first irrigation head, where it waters the grass or one or more plants located in proximity to the first irrigation head.

In some embodiments, the fertilizer container 112 may comprise a safety closure, which in some embodiments, the fertilizer inlet 118 may further comprise a puncturing feature that can be used to puncture the safety closure when the fertilizer container 112 is connect to the fertilizer inlet 118.

As described herein, the fertilizer assembly 106 is positioned between the water supply 102 and a first irrigation head 107. In some embodiments, the fertilizer assembly 106 may be positioned in the irrigation system such that the fertilizer is only provided to a few of the irrigation heads or only to one particular irrigation head such that the fertilizer is provided to one tree. In some embodiments, the fertilizer assembly 106 may be installed inside a home, building, or other structure near water supply 102. In other embodiments, the fertilizer assembly 106 may be installed outside. The fertilizer assembly 106 may be installed at a fixed position of the irrigation system or it may be portable for use at different locations throughout the system. In some embodiments, the fertilizer assembly 106 may be used at one location in the irrigation system for the purpose of disposing one type of fertilizer, and then may be used at a different location in the irrigation system for the purpose of disposing a second type of fertilizer, depending on the season, soil conditions, or the conditions of a particular plant. In some embodiments, as shown in FIG. 2, the fertilizer valve 110 may further comprise a pole 126 for the fertilizer assembly to be installed into the ground or floor for stability

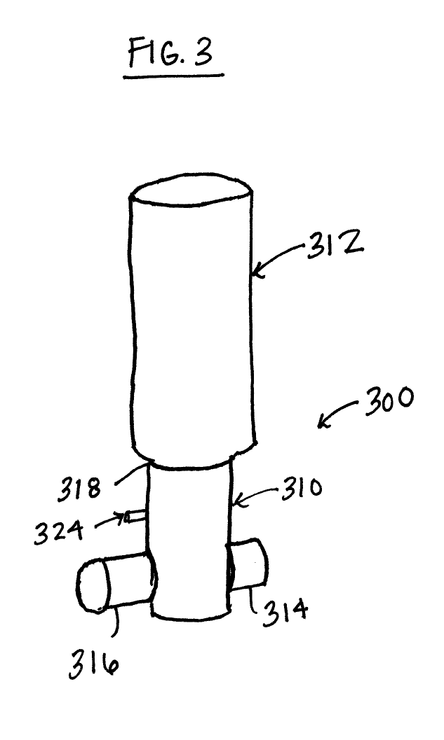

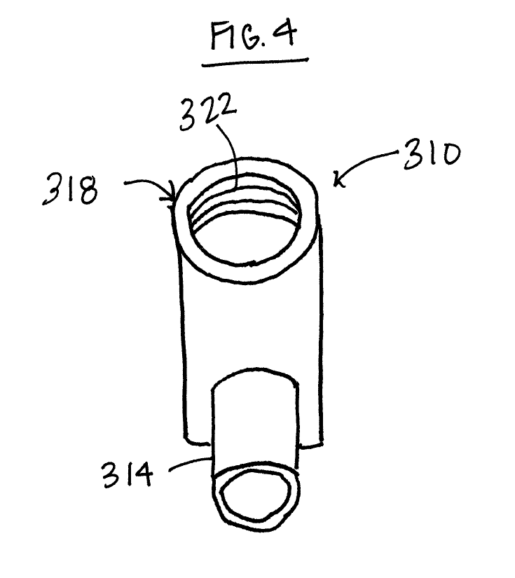

FIG. 3 shows one embodiment of a fertilizer assembly 306, which comprises a fertilizer valve 310 and a fertilizer container 312. FIG. 4 shows fertilizer valve 310 with the container disconnected. As shown in FIGS. 3-4, the fertilizer valve 310 comprises a generally cylindrical body having a water inlet 314 on a first side; an outlet 316 on a second side, the outlet 316 in line with the water inlet 314; and a fertilizer inlet 318 on the top. The fertilizer inlet 318 as shown in FIG. 4 comprises a threaded connector 322 that mates with a threaded connector (not shown) on fertilizer container 312. In at least the embodiment shown, the fertilizer valve 310 further comprises a shut-off feature 324 that determines how much fertilizer is distributed from the fertilizer container 312 and stops the feed of the fertilizer when the distributed fertilizer reaches a desired threshold.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. An irrigation system, comprising:
a water supply;
a plurality of irrigation heads in fluid connection with the water supply; and
a fertilizer assembly between the water supply and a first irrigation head, the fertilizer assembly in fluid connection with the water supply and the first irrigation head, the fertilizer assembly comprising a fertilizer valve connected to a fertilizer container with a stored amount of fertilizer.

2. The irrigation system of claim 1, wherein the fertilizer valve comprises:
a body having a top, a bottom, a first side, and a second side;
a water inlet on the first side;
an outlet on the second side, the outlet in fluid communication with the water inlet; and
a fertilizer inlet on the top of the body.

3. The irrigation system of claim 2, wherein the fertilizer valve further comprises a mixing chamber connected to the fertilizer inlet, the water inlet, and the water outlet.

4. The irrigation system of claim 3, wherein a portion of the stored amount of fertilizer is transferred to the mixing chamber based on gravity.

5. The irrigation system of claim 4, wherein the portion of the stored amount of fertilizer in the mixing chamber is combined with water provided from the water supply to form fertilized water.

6. The irrigation system of claim 6, wherein the fertilized water is transferred to the at least one of the irrigation heads.

7. The irrigation system of claim 2, wherein the fertilizer valve further comprises a first connector at the fertilizer inlet that connects with a second connector on the fertilizer container.

8. The irrigation system of claim 1, further comprising a sprinkler control valve between the fertilizer valve and the first irrigation head.

9. The irrigation system of claim 1, wherein the sprinkler control valve

10. The irrigation system of claim 1, wherein the fertilizer assembly is installed in a fixed position.

11. The irrigation system of claim 1, wherein the fertilizer assembly may be positioned between a second irrigation head and a third irrigation head.

12. The irrigation system of claim 1, wherein the fertilizer assembly is movable from a first installed position to a second installed position.

13. A fertilizer valve, comprising:
a body having a top, a bottom, a first side, and a second side;
a water inlet on the first side;
an outlet on the second side, the outlet in fluid communication with the water inlet; and a a fertilizer inlet on the top for connection with a fertilizer container.

14. The fertilizer valve of claim 13, further comprising a mixing chamber connected to the fertilizer inlet, the water inlet, and the water outlet.

15. The fertilizer valve of claim 13, further comprising a puncturing feature at the fertilizer inlet for opening a safety closure on the fertilizer container.

16. The fertilizer valve of claim 13, further comprising a shut-off feature that controls feed of fertilizer from the fertilizer container.

17. The fertilizer valve of claim 13, wherein the fertilizer inlet comprises a connector for connecting with a connector on a fertilizer container.

18. A method of fertilizing plants for an irrigation system having at least two irrigation heads comprising:
providing water from a water supply to a fertilizer assembly, which comprises a fertilizer valve connected to a fertilizer container with fertilizer, the fertilizer valve comprising a water inlet on one side, an outlet on another side in fluid communication with at least two irrigation heads, and a fertilizer inlet in communication with the fertilizer container;
mixing the water with fertilizer provided via gravity from the fertilizer container in the mixing chamber to form fertilized water;
providing the fertilized water to at least a first irrigation head.

19. The method of claim 18, further comprising connecting a fertilizer container to the fertilizer inlet.

20. The method of claim 18, further comprising controlling an amount of fertilizer distributed from the fertilizer container.
